(19) United States
(12) Patent Application Publication
(10) Pub. No.: US 2007/0268843 A1
(43) Pub. Date: Nov. 22, 2007

(54) Segmented Code Division Multiple Access

(75) Inventors: Benjamin A. Pontano, Gaithersburg, MD (US); Thomas Inukai, Gaithersburg, MD (US)

Correspondence Address: TOWNSEND AND TOWNSEND AND CREW LLP;VIASAT, INC (CLIENT #017018), TWO EMBARCADERO CENTER, EIGHTH FLOOR, CA, 94111, US

(73) Assignee: ViaSat, Inc., Carlsbad, CA (US)

(21) Appl. No.: 11/751,824

(22) Filed: May 22, 2007

Related U.S. Application Data
(60) Provisional application No. 60/747,849, filed on May 22, 2006.

(51) Int. Cl. H04L 12/28

(52) U.S. Cl. 370/258

(57) ABSTRACT

The present disclosure provides for methods and systems for segmented spread-spectrum communication according to one embodiment of the invention. Segmented spread-spectrum communication may include replicating a signal, spreading each of the replicated signals with a code, and modulating each of the coded signals within a unique spectral segment. The spectral segments may be uniform or nonuniform in width and may or may not be contiguous within the spectrum. The receive processing may include interference detection within a spectral segment. In response to detected interference, spectral segments may be discarded, a signal gain of each segment may be adjusted according to the level of interference, and/or selected segments may be adjusted according to the level of interference. Moreover, at the receiver a number of transmitted spectral segments may be combined. As a further embodiment, a plurality of signals may spread among a plurality of spectral segments.

### CROSS-REFERENCES TO RELATED APPLICATIONS

This application is a non-provisional, and claims the benefit, of co-pending, commonly assigned, U.S. Provisional Application No. 60/747,849, filed on May 22, 2006, entitled “Segmented Code Division Multiple Access,” the entirety of which is herein incorporated by reference for all purposes.

### BACKGROUND OF THE INVENTION

This disclosure relates in general to spread-spectrum communication and, but not by way of limitation, to segmented spread-spectrum communication amongst other things.

Classical code division multiple access (CDMA) is a fairly inflexible multiple access technique that requires large amounts of contiguous bandwidth. Low rate data signals are multiplied by high rate spreading codes to generate wide spectrum CDMA signals. The advantages of these techniques are well known and include resistance to multiple access interference, intentional jamming interference, and narrowband fading.

All of these listed advantages are enhanced as the spreading ratio and bandwidth increase. For example, a user may increase the rate of the spreading code in order to gain more immunity from interference. As the rate increases, the bandwidth of the transmission signal increases and eventually the user encounters a limitation based on the specific communication channel he has chosen. In a satellite communication system, bandwidth may be available in fragments in transponders. In conventional CDMA techniques, the fragmented bandwidth limitation will determine the maximum spreading gain that can be employed. There is a general need for communication schemes with improved interference and jamming immunity as well as bandwidth allocation flexibility.

### BRIEF SUMMARY OF THE INVENTION

A method for segmented spread-spectrum communication is disclosed according to one embodiment of the invention. The method includes segmenting the available frequency bandwidth into one or more spectral segments or using unassigned multiple fragmented bandwidths. The spectral segments may be of uniform or nonuniform width and/or contiguous or noncontiguous. The spectral segments may also be used by different transponders. Each spectral segment may be assigned a code according to a segmentation plan. A user signal received is replicated into a plurality of signals for transmission. Each of these signals may be encoded using a plurality of codes or a code matrix or matrices, for example, pseudo-noise (PN) codes. Any number of coding functions may be used to encode the signals. The coding effectively spreads the signal within the spectral segment. The encoded signals are then modulated within the spectral segment according to a segmentation plan. The method may also include various filtering and/or amplification processes, such as, for example, wave form shaping.

At the receiving end, multiple segments of the transmitted signal may be down-converted, filtered, despread, demodulated and combined to recover the user data. The method may further include detecting interference within at least one spectral segment. The interference detection may include measuring the power within a spectral segment at the receiver and/or receiving a communication from a receiver regarding detection of interference at a frequency segment at the transmitter. The interference may include jamming signals. According to one embodiment of the invention, spectral segments with interference may be removed from the segmentation plan. According to another embodiment, the transmitter stops transmission at the spectral segment with interference and reallocates the power of that segment to other spectral segments which have no interference. According to yet another embodiment, the method may include reassigning the signals at an at least one spectral segment with interference to another spectral segment. And, according to yet another embodiment, the signals received in each spectral segment may be multiplied at the receiver before signal combining, according to the interference level detected in the spectral segment. The gain adjustment (interference multiplier) may be properly chosen for each spectral segment to maximize performance after combining the signals.

Another embodiment of the invention includes receiving a plurality of signals, replicating the signals into n signals where n is the number of spectral segments in the segmentation plan. Each of the n coded signals may then be summed with a replicated and coded signal from the other plurality of signals and the summed signal transmitted within a spectral segment. The codes and the spectral segments may be associated within the segmentation plan. Such a system may provide multiple access to users across a segmented spectral communication system.

Another method for segmented spread-spectrum communication is provided according to another embodiment of the invention. The method includes segmenting the available frequency bandwidth into one or more spectral segments. The available frequency bandwidth may be noncontiguous and nonuniform and may be available through a number of transponders. A user signal received is replicated into a plurality of signals for transmission. Each of the signals is spread across a spectral segment according to a segmentation plan and using a plurality of codes or a code matrix. The spread signals may then be transformed into the frequency domain, for example, using a Fast Fourier Transform (FFT). The resulting signals may then be reordered according to the segmentation plan. The signals may then be converted back into the time domain, for example, using an inverse FFT.

Various other features of the embodiments of the invention may be included. For example, the codes used for encoding or spreading signals through a bandwidth may include pseudorandom noise codes and/or Hadamard codes. The spectra segments may include contiguous or noncontiguous spectra and may be uniform or nonuniform in width.

A method for receiving a segmented spread-spectrum communication is disclosed according to another embodiment of the invention. The method includes receiving a segmented spread-spectrum signal that is spread across one or more noncontiguous spectral segments according to a segmentation plan and includes a plurality of signals. The method further includes demodulating the segmented spread-spectrum signal according to the segmentation plan. The signals may be despread by multiplying the signals with the same code that was used to spread the signals. The method may also include transforming the signal into a plurality of frequency domain signals. Moreover, the signals may be match-filtered and transformed into the time domain. The signals may then be combined using a soft addition function and/or by averaging the received signals.

A system for communicating between a transmitter and receiver is disclosed according to another embodiment of the invention. According to this embodiment, a signal is transmitted from the transmitter to a receiver. The signal is segmented into one or more spectral segments. These spectral segments may be contiguous or noncontiguous. Interference detection may also occur at each of the spectral segments. When interference is discovered, the receiver communicates to the transmitter which spectral segment encountered the interference. The transmitter may then adjust the segmentation plan to deal with the interference in a spectral segment, for example, by one or more of the following: 1) removing from the segmentation plan at least one spectral segment where interference was detected; 2) increasing the power of the spectral segments at the each of the spectral segments, except the spectral segment where interference was detected and/or; 3) reassigning the signals transmitted from at least one spectral segment where interference was detected to another spectral segment.

### BRIEF DESCRIPTION OF THE DRAWINGS

FIG. 1A shows contiguous spectral segments in a broad spectral segment according to one embodiment of the invention.

FIG. 1B shows noncontiguous spectral segments of uniform widths according to one embodiment of the invention.

FIG. 1C shows noncontiguous spectral segments of nonuniform widths according to one embodiment of the invention.

FIG. 2A shows three noncontiguous and nonuniform spectral segments according to one embodiment of the invention.

FIG. 2B shows three noncontiguous and nonuniform spectral segments as received by a receiver with increased power at one of the spectral segments according to one embodiment of the invention.

FIG. 2C shows the spectral segments of FIG. 2B with a spectral segment encountering interference removed according to one embodiment of the invention.

FIG. 2D shows three noncontiguous and nonuniform spectral segments with one spectral segment reassigned to a new spectral segment to avoid interference according to one embodiment of the invention.

FIG. 2E shows three noncontiguous and nonuniform spectral segments with power reallocated among spectral segments when interference is encountered at one spectral segment according to one embodiment of the invention.

FIG. 3 shows a functional transmission segment processing block diagram according to one embodiment of the invention.

FIG. 4 shows a functional receiver segment processing block diagram according to one embodiment of the invention.

FIG. 5 is a block diagram of a transmitter according to one embodiment of the invention.

FIG. 6 is a block diagram of a receiver according to one embodiment of the invention.

FIG. 7 is a flowchart showing a data signal processed at a transmitter according to one embodiment of the invention.

FIG. 8 is a flowchart showing a data signal processed at a receiver according to one embodiment of the invention.

FIG. 9 is a flowchart showing autonomous interference avoiding between a transmitter and receiver according to one embodiment of the invention.

FIG. 10 shows a flowchart of creating a segmentation plan according to one embodiment of the invention.

FIGS. 11A and 11B show Hadamard codes applied to 2 and 8 segments, respectively, according to one embodiment of the invention.

FIG. 12 shows a functional transmission segment processing block diagram for multiple signals according to one embodiment of the invention.

FIG. 13 is a flowchart showing a plurality of data signals processed at a transmitter according to one embodiment of the invention.

In the appended figures, similar components and/or features may have the same reference label. Further, various components of the same type may be distinguished by following the reference label with a dash and a second label that distinguishes among the similar components. If only the first reference label is used in the specification, the description is applicable to any one of the similar components having the same first reference label irrespective of the second reference label.

### DETAILED DESCRIPTION OF THE INVENTION

The ensuing description provides preferred exemplary embodiment(s) only and is not intended to limit the scope, applicability or configuration of the disclosure. Rather, the ensuing description of the preferred exemplary embodiment(s) will provide those skilled in the art with an enabling description for implementing a preferred exemplary embodiment. It should be understood that various changes may be made in the function and arrangement of elements without departing from the spirit and scope as set forth in the appended claims.

A segmented spread-spectrum communication system is disclosed according to one embodiment of the invention. The system permits communication between at least one receiver and at least one transmitter using contiguous and noncontiguous spectral segments. The system may also provide improved broadband and narrow band interference immunity, anti-jamming, decreases in selective fading effects, improved multipath resistance, and usable bandwidth flexibility.

A transmitter that transmits a segmented spread-spectrum signal over a plurality of noncontiguous spectral segments is also disclosed according to another embodiment of the invention. Likewise, a receiver that receives a segmented spread-spectrum signal over a plurality of noncontiguous spectral segments is disclosed. Such a transmitter and a receiver may be in communication with each other and may be employed in satellite or terrestrial communications. The transmitter and/or receiver may monitor signal segments for signs of interference and/or jamming at specific frequencies or spectral segments. If jamming or interference is found, a transmitter, a receiver or a transmitter-receiver pair may adjust the power of the signal transmitter over the spectral segment where interference or jamming was identified or cease using the frequency or spectral segment altogether. The receiver may also disregard the segmented spectral segment where interference was found. Moreover, the receiver may weight signals according to the measured interference within the spectral segments.

Methods for creating and receiving a segmented spread-spectrum communication signal are also disclosed according to one embodiment of the invention. The method may include replicating the signal, spreading the signal with codes and transmitting the signal amongst a plurality of spectral segments. Other embodiments include spreading a plurality of signals across a noncontiguous spectrum using various coding techniques.

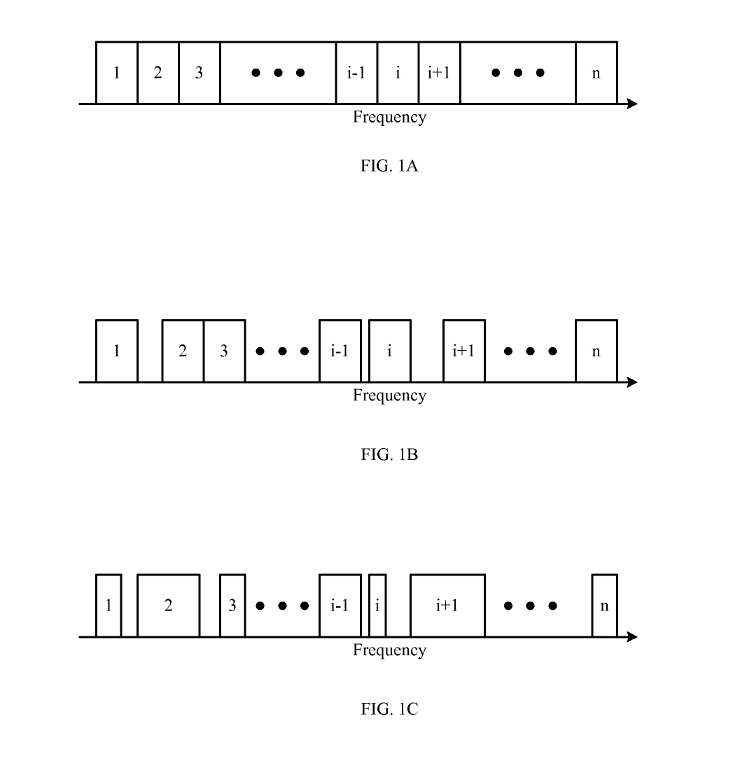

FIGS. 1A, 1B and 1C show spectral segmentation schemes according to various embodiments of the invention. FIG. 1A shows a contiguous and uniform segmented spectrum according to one embodiment of the invention. The spectrum is broken into n contiguous and uniform segments. Similarly, FIG. 1B shows a spectrum of n uniform segments where a number of the segments are noncontiguous. FIG. 1C shows n nonuniform and noncontiguous spectrum segments.

A signal may be spread among each of the spectral segments shown in FIGS. 1A, 1B and 1C. For example, a signal may be replicated into n signals and coded using any number of coding techniques. Each of the n coded signals may then be transmitted on a broadband carrier frequency as shown in FIGS. 1A, 1B and 1C. The codes and the spectral segments may correlate as noted in a segmentation plan. The spreading gain of the transmitted signal may be calculated as the ratio of the sum of the bandwidths of the spectral segments and the transmission rate of the signal. Accordingly, the spreading gain achievable across a noncontiguous spread-spectrum may be the same as the spreading gain achievable if the spectral segments were contiguous and/or continuous. Moreover, in some embodiments, the spreading gain is comparable to the spreading gain of a CDMA communications system.

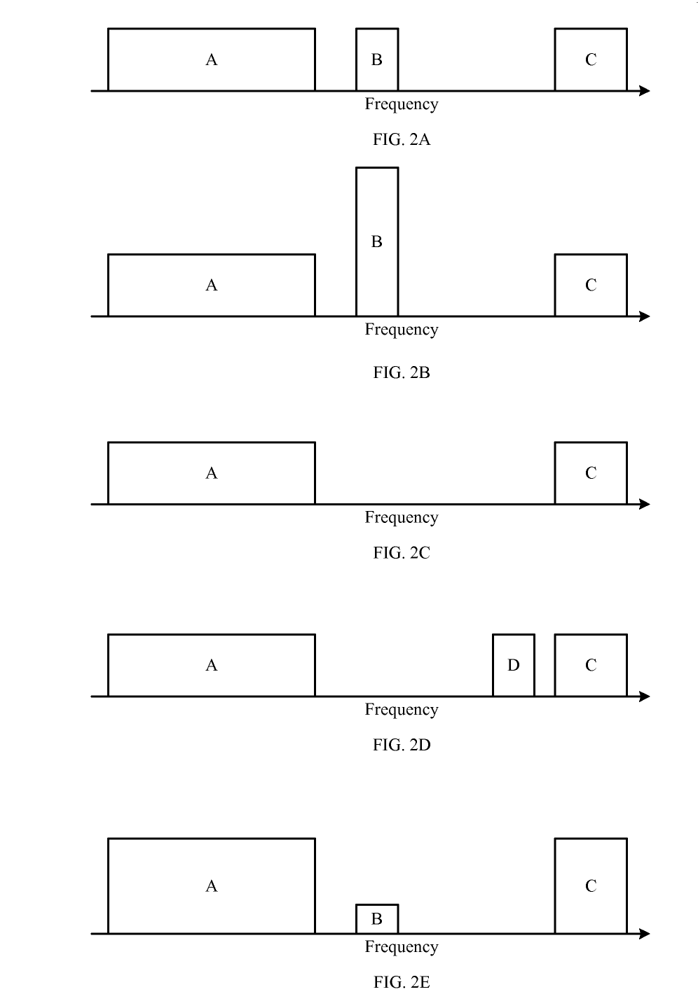

Anti-jamming and interference immunity techniques may be achievable with a segmented spread-spectrum communication scheme. For example, FIG. 2A shows a segmented spectrum with 3 spectral segments (A, B, C) according to one embodiment of the invention. A transmitter may replicate a signal into three signals, code the three signals according to a segmentation plan, and then transmit the coded signals within each of the three spectral segments (A, B, C). As shown in FIG. 2A, the power of the signal during transmission is represented by the height of the spectral segment. Due to interference and/or jamming in the channel during transmission, the receiver may detect increased power within one of the spectral segments, or at frequency within one of the spectral segments, as shown by segment B in FIG. 2B. Accordingly, as shown in FIG. 2C, the spectral segment B may be removed from the segmentation plan. The spectral segment B may be dismissed at the receiver as long as the interference and/or jamming occur. The transmitter may also remove the spectral segment from the segmentation plan and, accordingly, not transmit a signal at the spectral segment. A new spectral segment, segment D, may be included in the segmentation plan to compensate for the lost signal as shown by segment D in FIG. 2D. FIG. 2E shows an alternate scheme to avoid jamming and/or interference. Rather than remove the segment and/or replace it with another segment outside the jamming and/or interference, the power of the other segments may be increased and the power of the interfered or jammed signal may be decreased by the transmitter during transmission. Such embodiments and/or methods may provide increased interference immunity from all types of narrow band interferences and/or jamming.

Embodiments of the invention may provide for improved multipath effects. The spreading and coding of the signal or signals according to a segmentation plan may provide diversity that minimizes multipath effects common in a communication scheme. The performance of embodiment of the invention may provide multipath performance that is enhanced in comparison to the multipath performance of CDMA communications or other signal spreading systems.

Moreover, spreading a signal or signals over noncontiguous spectral segments provides increased interference immunity and anti-jamming over other broadband schemes. For example, the use of noncontiguous spectral segments provides multiple communication channels. For jamming or interference to have a substantial effect on communication performance, interference or jamming must occur at a significant number of spectral segments rather than at a single broadband segment. Simply put channels at frequencies experiencing increased interference and/or jamming may be avoided using a plurality of spectral segments using embodiments of the present invention.

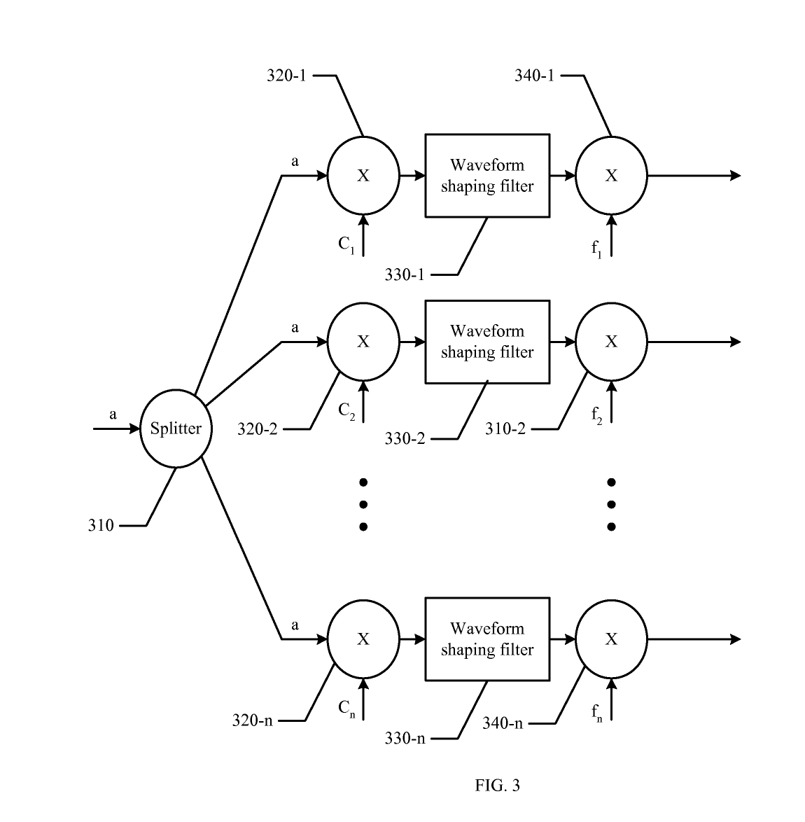

FIG. 3 shows a block diagram of a portion of a transmitter sending segmented spread-spectrum signals according to one embodiment of the invention. A signal, a, is replicated into n signals at a splitter 310. The splitter returns n signals identical to the input signal. Each of the n copies of a are then coded with codes from the segmentation plan at coder 320. For example, each of the signals may be multiplied with a unique code. Once the codes have been applied to the signals, the signals may be shaped and/or prepared for transmission with a waveform-shaping filter 330. Following the wave form shaping filter 330, the signals may be modulated according to a specific spectral segment using a modulator 340. Each modulator modulates at a frequency according to the segmentation plan. Further processing, filtering and/or amplification of the signals may occur prior to transmission.

In another embodiment of the invention, a plurality of signals may be transmitted using segmented spread-spectrum signals. A plurality of signals aₙ may be received and segmented independently. Each signal at each spectral segment may be encoded using a unique code. Accordingly, each of the signals is encoded using a unique code at each of the spectral segments prior to transmission. Moreover, each of the signals is still transmitted over each spectral segment. The codes may be associated with a specific users and/or receivers. Accordingly, while each receiver may receive each of the signals spread across all the spectral segments, the receiver may only decode the signals according to the codes assigned to the receiver. Accordingly, multiple receivers may receive different signals from the same transmitter. Moreover, multiple transmitters may communicate with a single receiver. Each of the transmitters may apply a unique code and spread the signal across spectral segments according to the segmentation plan. The receiver may receive all the signals and decode each of the signals using the proper codes.

The codes, used in the various embodiments of the invention, may introduce a random noise like quality to the signal. These codes may be a pseudorandom sequence of 1 and −1 values, at a frequency much higher than that of the original signal. Each of the codes may be orthogonal and may also include Walsh or Hadamard sequences or matrices and/or pseudo noise (PN) codes. Other coding schemes may also be used. Applying such codes may spread the power of the original signal into a much wider spectral segment. The codes effectively spread the signal within the spectral segments according to the segmentation plan. After the codes are applied to the signals, the resulting signal may resemble white noise. The coded signal may then be transmitted, and the receiver can be used to exactly reconstruct the original data at the receiving end, by multiplying it by the same code.

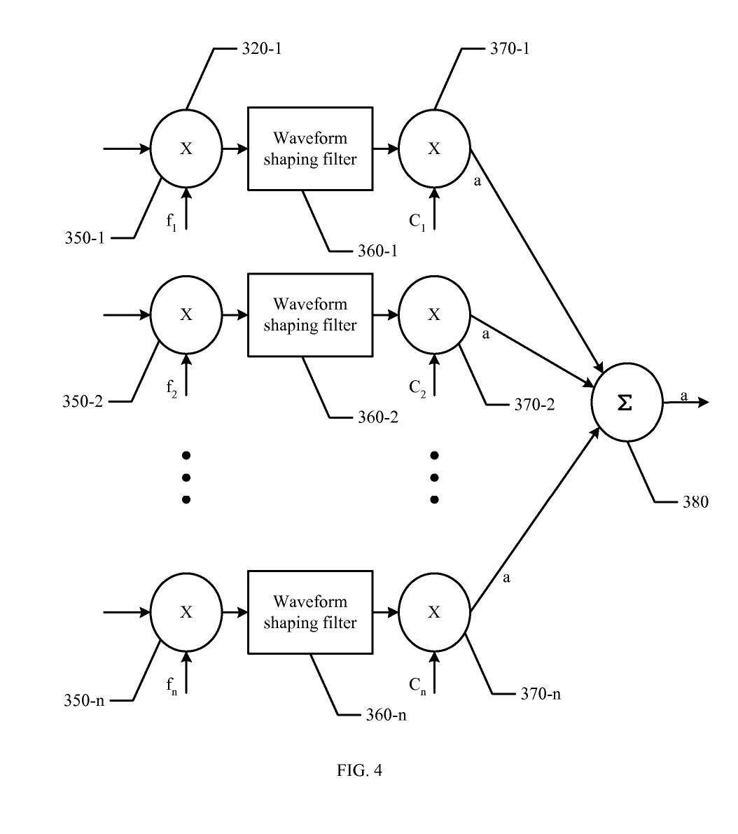

FIG. 4 shows a block diagram of a portion of a receiver that receives segmented spread-spectrum signals according to one embodiment of the invention. The receiver receives signals within each of the spectral segments as dictated by the segmentation plan and demodulates each of the signals with a demodulator 350 according to the segmentation plan. The demodulated signals may then be filtered with a waveform-shaping filter 360. Following the filter, the signals may then be decoded according to the segmentation plan at decoder 370. For example, the decoding may multiply the received signals by the code that created the signal according to the segmentation plan. Following the decoder the plurality of signals are combined using a soft addition operation 380. The soft addition, for example, may average the signals.

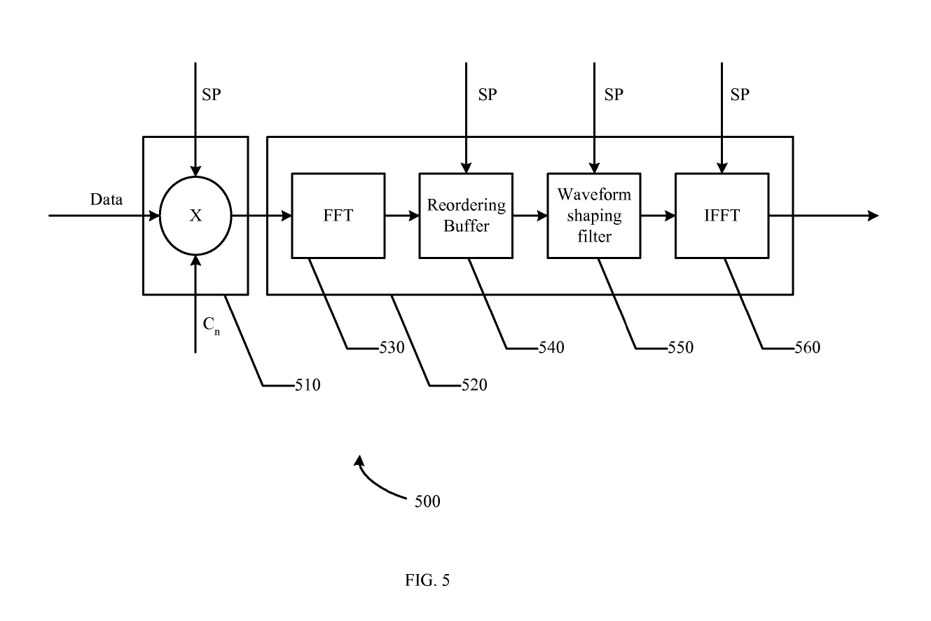

FIG. 5 shows a transmitter 500 that includes a shared spreader 510 and a shared modulator 520 according to one embodiment of the invention. The shared spreader 510 may apply codes (cₙ) to a signal that is split into a plurality of signals. The shared spreader applies a code to each of the signals in accordance with a coding scheme as dictated by the segmentation plan. A single signal or multiple signals may be output from the shared spreader 510 into the shared modulator 520.

The shared modulator 520 may then convert the single signal into the frequency domain using a Fast Fourier Transform (FFT) 530. Once in the frequency domain, the reordering buffer 540 may then assign the frequency coefficients of the various signals to spectral locations according to the segmentation plan. For example, for frequencies where the signal is not being transmitted, zero padding may be applied to these frequencies. Waveform-shaping with a filter 550, for example, a square root raised cosine may then be performed in the frequency domain by simply multiplying every signal sample by an appropriate coefficient to provide the desired shaping. An inverse FFT (IFFT) may then be performed to bring the composite signal back to the time domain. An overlap, save or overlap, and/or add operation may be performed at the FFT and/or IFFT in order to avoid data loss. Following the IFFT, the receiver 500 may employ a digital-to-analog converter to convert the signals into analog prior to transmission. The signals may also be upconverted prior to transmission.

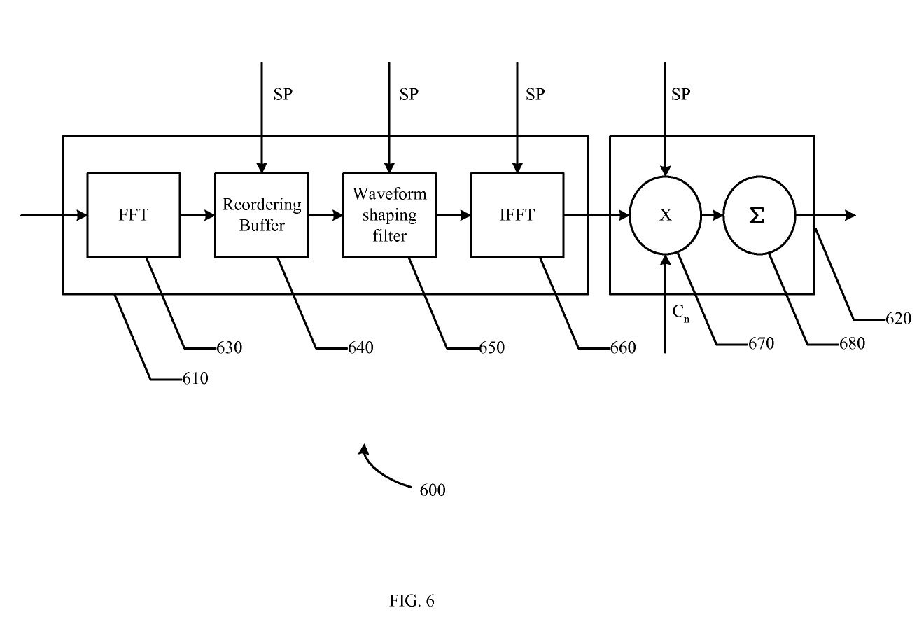

FIG. 6 shows a receiver 600 that includes a shared demodulator 610 and a shared despreader 620 according to one embodiment of the invention. At the receiver 600, the samples may initially be downconverted and digitized. At the shared demodulator 610, the samples may then be transformed to the frequency domain using a FFT 630. The samples from the assigned segments may then be selected according to the segmentation plan at the reordering buffer 640. The individual samples may then be matched-filtered in the frequency domain using simple coefficient multiplication at the wave form shaping filter 650. IFFTs 660 may then be performed on the individual segments to bring the individual spread signals back to the time domain. Similar to the transmitter 500, an overlap, save or overlap, and/or add operation may be performed at the FFT and/or IFFT in order to avoid data loss.

The shared despreader 620 may then be used to perform the despreading of the individual signals by applying the codes to the signals at a decoder 670 according to the segmentation plan. A soft decision addition 680 may be performed where corresponding despread samples from each segment are added using, for example, a soft decision decoding.

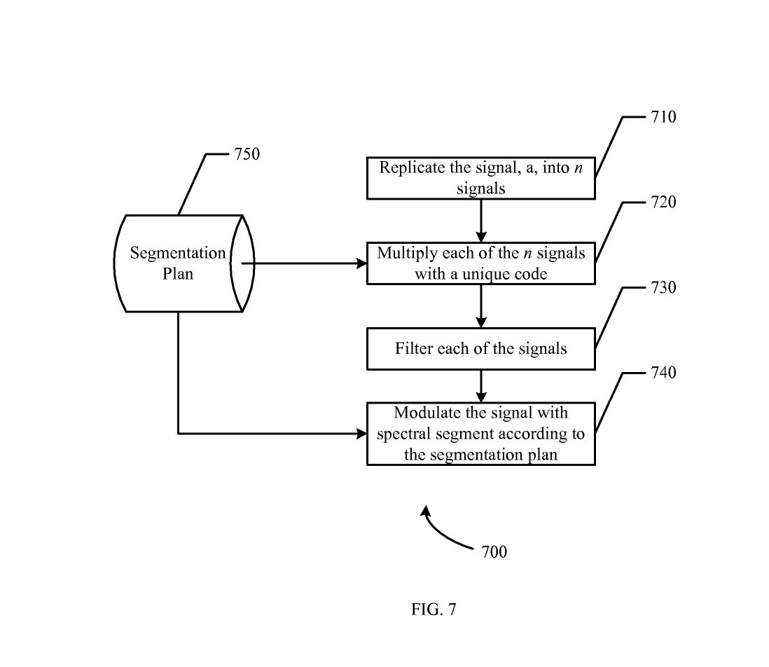

FIG. 7 shows a flowchart 700 showing a method for preparing a signal for transmission using a segmented spread-spectrum according to one embodiment of the invention. A digital signal, a, is received and replicated into n signals according to the segmentation plan at block 710. Each of the n signals are then multiplied by a unique code at block 720. The codes may be dictated by the segmentation plan 750 and correlated with the spectral segment within which the signal will be transmitted.

The signals may then be filtered at block 730. For example, the signal may be multiplied by a square root raised cosine function. Each waveform is then modulated with a spectral segment according to the segmentation plan 750 at block 740. After block 740, the signals may be transmitted.

The segmentation plan may include a plurality of codes associated with a plurality of contiguous and/or noncontiguous spectral segments. The segmentation plan may coordinate which code will be used with which spectral segment. The segmentation plan may also be a dynamic plan that associates available bandwidth and/or bandwidth segments with codes and adjusts the bandwidth and/or bandwidth segments over time in response to interference, jamming and/or availability of bandwidth and/or bandwidth segments.

Embodiments of the invention may also apply in situations where a user has communication needs that require a specific bandwidth, yet a continuous bandwidth is unavailable. For example, a user may require a transmission with a transmission rate of 5 MHz and a spreading gain of 10, for a total bandwidth of 50 MHz in a satellite communications scheme. However, if such bandwidth is unavailable or too expensive, embodiments of the invention may be used to spread the bandwidth over noncontiguous spectral segments. Accordingly, the user may use five 10 MHz spectral segments (contiguous and/or noncontiguous spectral segments) with a spreading gain of 2 in order to produce a transmission with 50 MHz of bandwidth as required.

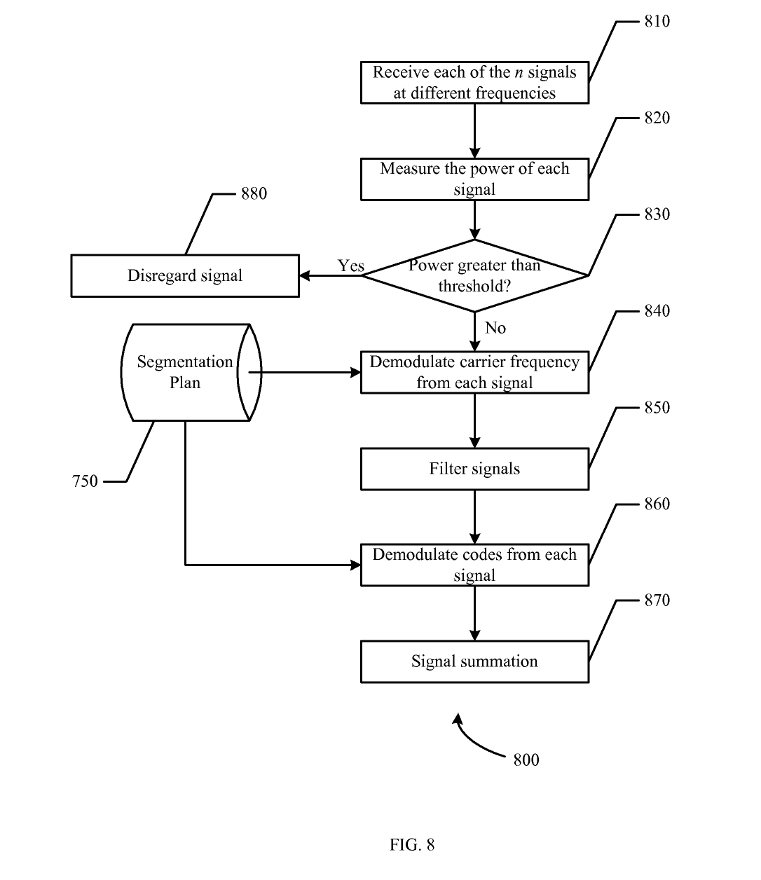

FIG. 8 shows a flowchart 800 showing a method for receiving a signal using a segmented spread-spectrum according to one embodiment of the invention. A plurality of signals is received 810 at the receiver from a plurality of different spectral segments. The power of each signal is measured at block 820 and then a determination is made whether the power of each signal is greater than a threshold at block 830. If the power is greater than a set threshold it is likely that the signal encountered interference and/or a jamming in the channel. The received signal may then be removed if the power is greater than a threshold value at block 880.

Each of the received signals may then be demodulated from the carrier frequency according to the segmentation plan at block 840. The signals may then be filtered, for example, with a waveform-shaping function, at block 850. The codes may then be applied to the signals according to the segmentation plan at block 860. The plurality of signals may be added at block 870. The signal summation may include a soft addition function or an average of the signals.

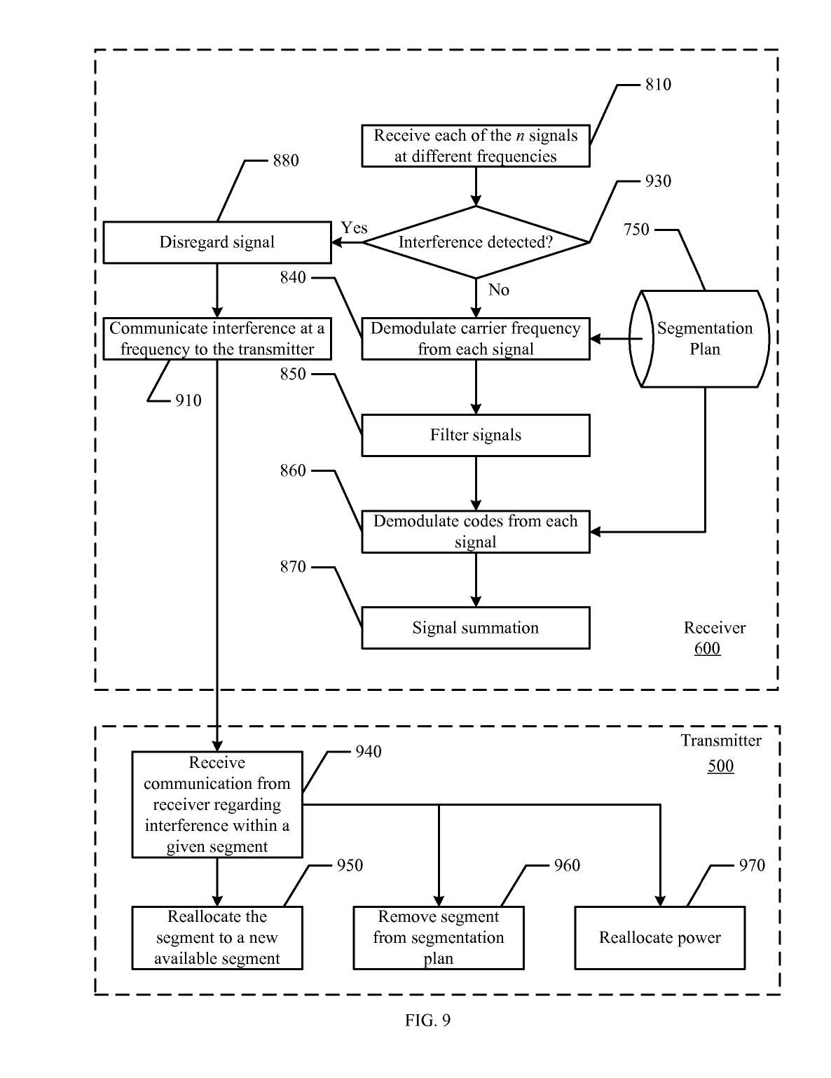

FIG. 9 shows a flowchart 900 showing a method for autonomously adjusting the segmentation plan in response to interference and/or jamming in a communication channel at a frequency and/or frequency band and/or spectral segment according to one embodiment of the invention. The flowchart shows a method operating within a transmitter 500 and a receiver 600. The receiver 600 receives n signals at different frequencies 810. The system then determines whether interference was encountered in the channel between the transmitter 600 and the receiver 500 at a frequency segment within the segmentation plan at block 930. Interference may include a jamming signal.

If interference was found in any of the signals, then the signal is disregarded at block 880. The receiver 500 then communicates to the transmitter 600 that interference was detected within the frequency segment associated with the signal at block 910. The communication is received at the transmitter 500 at block 940. Various communication schemes may be employed to communicate interference segments to the transmitter. The transmitter may then do one or more of the following: 1) reallocate the segment that encounters interference to a new available segment at block 950 and as discussed in regard to FIG. 2C; 2) the transmitter may remove the segment that encounters interference at block 960; 3) the transmitter may reallocate the transmission power to other spectral segments at block 970 and as described in regard to FIG. 2D. The power reallocation may be adjusted dynamically based on the level of interference detected at various spectral segments. For example, if the interference level is high within a given spectral segment, then the power associated with that spectral segment will be decreased to a greater degree than if the interference level were lower. The transmission power is allocated among the other spectral segments. The allocation may be based on interference levels at these other spectral segments as well.

Each of the received signals in spectral segments that were not previously disregarded may then be demodulated from the carrier frequency according to the segmentation plan at block 840. The signals may then be filtered, for example, with a waveform-shaping function, at block 850. The codes may then be applied to the signals according to the segmentation plan at block 860. The plurality of signals may be added at block 870. The signal summation may include a soft addition function or an average of the signals.

According to another embodiment of the invention, the receiver may also weight each received signal according to the measured interference levels at each spectral segment. Spectral segments with high interference are not dismissed. At the signal summation, block 870, a weighted average may be applied to the signals based on the level of interference measured in each spectral segment.

The receiver and transmitter, in embodiments of the invention, may require synchronization in order to despread the signals. A timing signal or timing search process may be used by the receiver to coordinate timing with the transmitter. Various other timing schemes may also be employed.

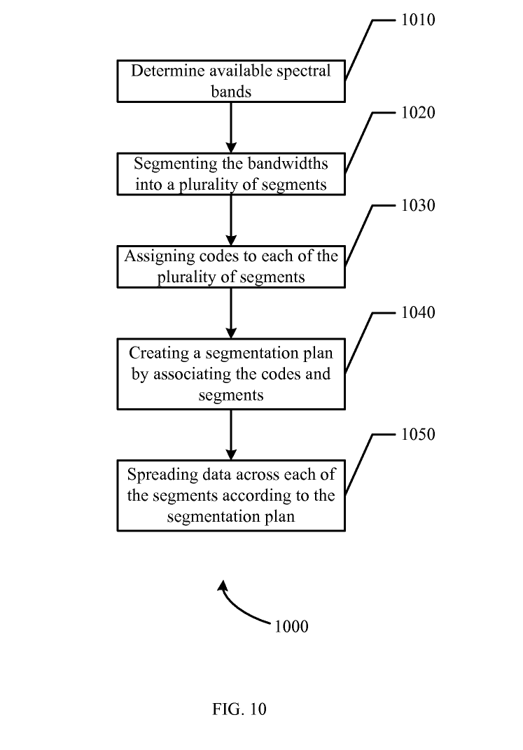

FIG. 10 shows a flowchart making and using a segmentation plan according to one embodiment of the invention. The available bandwidth and/or bandwidths are determined at block 1010. The available bandwidth or bandwidths may be contiguous, noncontiguous, or a combination. The bandwidth segments may also be of uniform or nonuniform widths. The available bandwidths may be available at more than one transponder or satellite. The available bandwidth and/or bandwidths are segmented into a plurality of spectral segments 1020. Codes are assigned to each of the spectral segments at block 1030. The codes and spectral segments are associated creating a segmentation plan at block 1040. The segmentation plan may then be used to spread a signal across a plurality of the segments and/or segment bands at block 1050.

In another embodiment of the invention, a signal is replicated into a plurality of signals for transmission over a plurality of segmented bands. Each of the signals is transmitted over a bandwidth segment using direct sequence code division multiple access (CDMA). The receiver despreads the signals using CDMA decoding.

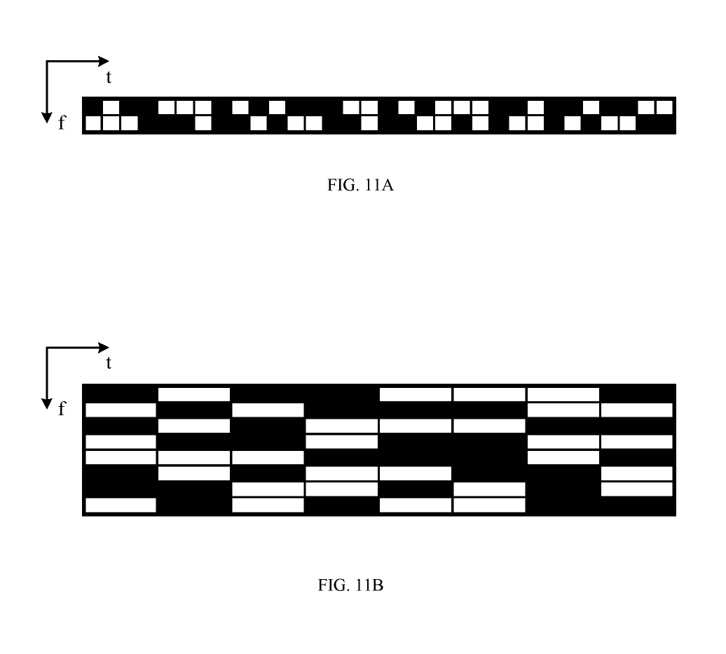

FIGS. 11A and 11B show Hadamard codes that may be used to spread signals according to one embodiment of the invention. A 64-chip Hadamard code may be used to encode signals. If one segment is used all 64 chips are used to encode the signal. If two segments are used, each of the segments uses half of the 64-chip Hadamard code. The first segment is assigned the first 32 chips and the second segment is assigned the second 32 chips as shown in FIG. 11A. Similarly, if eight segments are used, as shown in FIG. 11B, the Hadamard codes are separated into eight 8 chip codes that are applied to the eight segments.

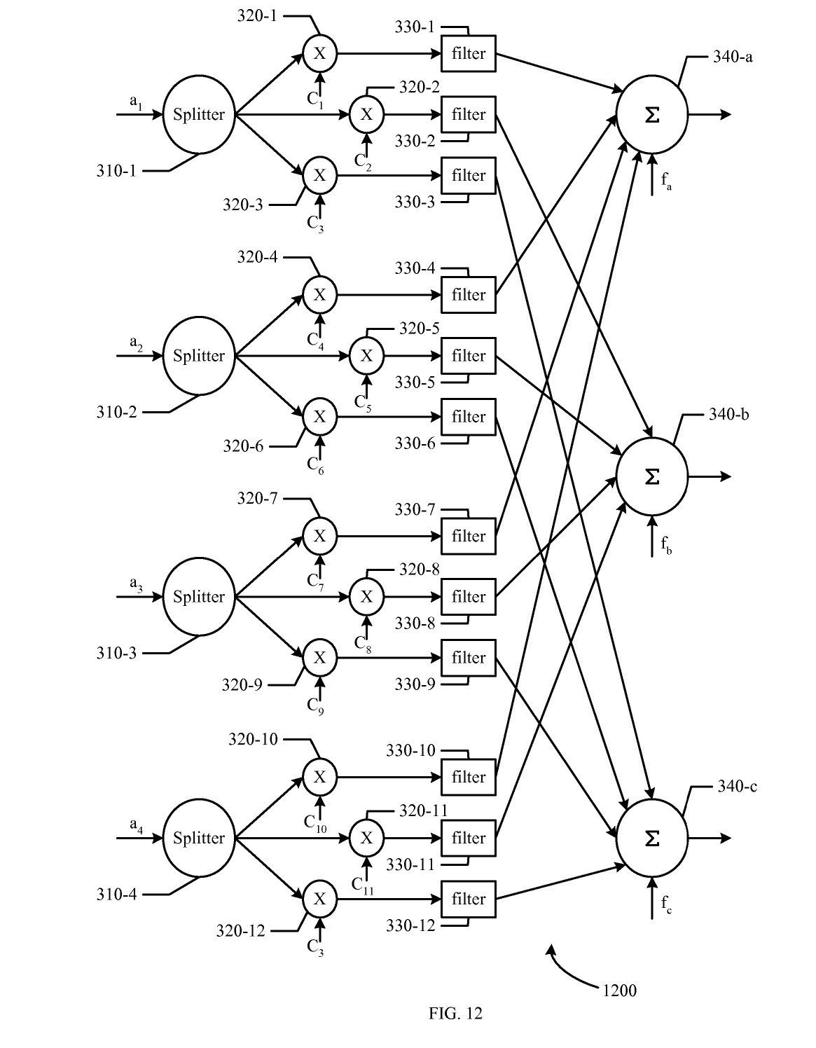

FIG. 12 shows a functional transmission segment processing block diagram 1200 for multiple signals according to one embodiment of the invention. FIG. 12 shows four signals (a₁, a₂, a₃, a₄) replicated, filtered, coded and transmitted through three spectral segments. While only four signals and three spectral segments are shown, the embodiments of the invention are not limited by the number of signals and/or the number of spectral segments that may be employed. Each of the four signals may include specific signals that are to be transmitted to unique users and/or receivers. Accordingly, the codes used to encode a signal may only be held by the receiver and, therefore, may only be decoded at a specific receiver. Communication from the receiver back to the transmitter may similarly use the same codes.

Looking first at signal a₁ at the top of the block diagram 1200, the signal a₁ is replicated at a splitter 310-1 into three signals. The three signals correspond with the number of spectral segments in the segmentation plan. Each of the three signals are then encoded with a unique code 320-1, 320-2, 320-3. The three encoded signals may then be filtered 330-1, 330-2, 330-3. The filtering may include any signal processing and/or filtering and may include filtering in preparation for transmission. Moreover the filtering may not be necessary. Similarly, the other three signals may be replicated 310-2, 310-3, 310-4, coded 320-4, 320-5, 320-6, 320-7, 320-8, 320-9, 320-10, 320-11, 320-12 and filtered 330-4, 330-5, 330-6, 330-7, 330-8, 330-9, 330-10, 330-11, 330-12. Replicated, coded, and filtered signals from each of the four three signals a₁ , a₂, a₃, a₄ are added together at 340-a, 340-b, 340-c. The four signals may also be modulated and transmitted within a spectral segment according to the segmentation plan 340-a, 340-b, 340-c. The receiver may despread the signals using available codes. As noted above, a receiver may not have all the codes but may, nonetheless, despread individual signals using the codes available. Interference immunity functions may also apply at the receiver and transmitter.

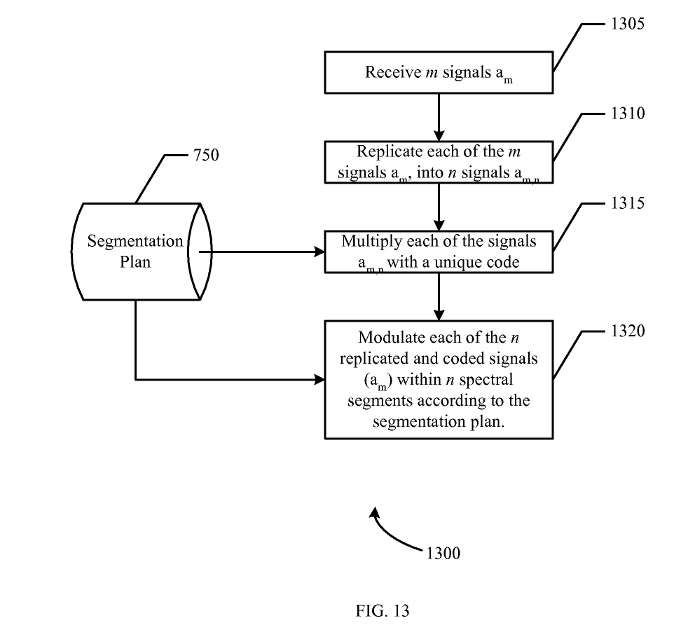

FIG. 13 is a flowchart showing a plurality of data signals processed at a transmitter according to one embodiment of the invention. At block 1305 m signals are received aₘ. The signals may then be replicated into n signals at block 1310. The number n corresponds with the number of spectral segments available as specified in the segmentation plan. Each of the signals may then be encoded with a unique code at block 1315. Each of these codes may include pseudo-random codes as discussed above. Each of the replicated and coded signals may then be modulated within a spectral segment according to the segmentation plan 750 at block 1320. An encoded replication of each of the aₘ signals are transmitted within each of the n spectral segments. Prior to modulation, each of the n signals may be summed. The orthogonality of the codes applied to each of the signals permits a receiver to despread the codes and reproduce the m when the codes are received.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine-readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine-readable mediums for storing information. The term “machine-readable medium” includes, but is not limited to portable or fixed storage devices, optical storage devices, wireless channels and/or various other mediums capable of storing, containing or carrying instruction(s) and/or data.

While the principles of the disclosure have been described above in connection with specific apparatuses and methods, it is to be clearly understood that this description is made only by way of example and not as limitation on the scope of the disclosure.

What is claimed is:

1. A method for segmented spread-spectrum communication, whereby the segmented spread-spectrum includes noncontiguous bandwidths, wherein the method comprises:
segmenting the available frequency bandwidth into a plurality of spectral segments and assigning each spectral segment a code according to a segmentation plan, wherein at least one of the plurality of spectral segments is noncontiguous with another spectral segment, whereby multipath effects are minimizeable through transmission of a signal through the plurality of spectral segments;
receiving a data signal;
replicating the data signal into a plurality of signals;
encoding each of the plurality of signals using a plurality of codes, wherein the encoding creates a plurality of encoded signals; and
modulating the plurality of encoded signals according to the segmentation plan,
whereby the spreading gain is the ratio of the sum of the bandwidths of the spectral segments and the transmission rate of the signal.

2. The method of claim 1, wherein the modulating comprises modulating the plurality of encoded signals within each of the spectral segments.

3. The method of claim 1, further comprising performing waveform-shaping.

4. The method of claim 1, further comprising detecting interference within at least one spectral segment of the plurality of spectral segments.

5. The method of claim 4, further comprising removing the at least one spectral segment with interference from the segmentation plan, whereby interference immunity is achievable at least through removing the at least one spectral segment.

6. The method of claim 4, further comprising:
decreasing the power at the at least one spectral segment with interference; and
increasing the power at each of the spectral segments except the at least one spectral segment with interference,
whereby interference immunity is achievable at least through such power changes.

7. The method of claim 4, further comprising reassigning the signals at the at least one spectral segment with interference to another spectral segment, whereby interference immunity is achievable at least through reassigning the signals.

8. The method of claim 1, wherein the signal comprises a plurality of signals, and the method further comprising:
receiving each of the plurality of data signals;
replicating each of the plurality of data signals into a plurality of replicated signals, wherein each of the plurality of replicated signals is identical to one of the plurality of data signals;
encoding each of the plurality of signals using a plurality of codes, wherein the encoding creates a plurality of encoded signals and each of the plurality of signals is encoded with a unique code; and
modulating the plurality of encoded signals according to the segmentation plan.

9. A method for segmented spread-spectrum communication, wherein the method comprises:
segmenting the available frequency bandwidth into plurality of spectral segments, wherein the segmenting creates a segmentation plan;
receiving a signal;
replicating the data signal into a plurality of signals;
encoding each of the plurality of signal using a plurality of codes, wherein the encoding creates a plurality of encoded signals, whereby multipath effects are minimizeable through transmission of a signal through the plurality of spectral segments;
transforming the plurality of encoded signals into the frequency domain according to the segmentation plan, wherein the transforming creates one or more frequency-domain signals;
reordering the plurality of frequency-domain signals according to the segmentation plan; and
converting the plurality of frequency-domain signals into the time domain,
whereby the spreading gain is the ratio of the sum of the bandwidths of the spectral segments and the transmission rate of the signal.

10. The method of claim 9, wherein the transforming comprises applying a Fast Fourier Transform to the plurality of encoded signals.

11. The method of claim 9, wherein the converting comprises applying an inverse Fast Fourier Transform to the plurality of frequency-domain signals.

12. The method of claim 9, further comprising transmitting the plurality of signals.

13. The method of claim 9, wherein the codes are selected from the group consisting of: pseudorandom noise codes and Hadamard codes.

14. The method of claim 9, wherein the plurality of spectral segments comprise one or more noncontiguous spectral segments.

15. The method of claim 9, further comprising detecting interference within at least one spectral segment of the plurality spectral segments.

16. The method of claim 15, wherein detecting interference within at least one spectral segment comprises measuring power at each of the plurality of spectral segments.

17. The method of claim 15, further comprising removing the at least one spectral segment with interference from the segmentation plan, whereby interference immunity is achievable at least through removing the at least one spectral segment.

18. The method of claim 15, further comprising:
decreasing the power at the at least one spectral segment with interference; and
increasing the power at each of the spectral segments except the at least one spectral segment with interference,
whereby interference immunity is achievable at least through the increasing and the decreasing.

19. The method of claim 15, further comprising reassigning the signal at the at least one spectral segment with interference to another spectral segment, whereby interference immunity is achievable at least through reassigning the signal.

20. A method for segmented spread-spectrum communication, whereby the segmented spread-spectrum includes noncontiguous bandwidths, wherein the method comprises:
receiving a segmented spread-spectrum signal, wherein the spread-spectrum signal is spread across one or more noncontiguous spectral segments according to a segmentation plan and the segmented spread-spectrum signal is received at a plurality of spectral segments, whereby multipath effects are minimizeable through transmission of a signal through the plurality of spectral segments;
demodulating the segmented spread-spectrum signal; and
despreading the segmented spread-spectrum signal using decoding techniques based on the segmentation plan,
whereby the spreading gain is the ratio of the sum of the bandwidths of the spectral segments and the transmission rate of the signal.

21. The method of claim 20, further comprising transforming the signal into a plurality of frequency domain signals.

22. The method of claim 21, further comprising:
match-filtering the plurality of frequency domain signals; and
transforming the plurality of signals into the time domain.

23. The method of claim 21, further comprising adding each of the signals received from each of the spectral segments.

24. The method of claim 20, further comprising selecting samples from the signal according to the segmentation plan.

25. The method of claim 20, wherein the despreading comprises applying codes to the spread-spectrum signal.

26. The method of claim 20, further comprising detecting interference at an at least one spectral segment.

27. The method of claim 26, wherein the detecting further comprises:
measuring the power in a spectral segment; and
determining whether the power is greater than a threshold level.

28. The method of claim 26, further comprising removing the at least one spectral segment with interference from the segmentation plan.

29. The method of claim 26, further comprising:
multiplying each of the spectral segments by an interference-multiplier, wherein the interference-multiplier is based on the level of interference detected in the spectral segment; and
adding each of the signals received from each of the spectral segments,
whereby interference immunity is achievable at least through the multiplying and the adding.

30. The method of claim 26, further comprising:
decreasing the power at the at the one spectral segment with interference; and
increasing the power at each of the spectral segments except the at least one spectral segment with interference.

31. The method of claim 26, further comprising communicating to a transmitter that interference is found at the at least one spectral segment with interference.

32. A system for communicating between a transmitter and receiver using segmented spread-spectrum communication, whereby interference immunity is substantially achievable, wherein:
a signal is transmitted from the transmitter to the receiver;
the signal is spread and segmented over available frequency bandwidth into a plurality of spectral segments, wherein at least one of the plurality of spectral segments is noncontiguous with another spectral segment;
detecting interference within at least one spectral segment at the receiver;
communicating from the receiver to the transmitter that the at least one spectral segment where interference was detected; and
adjusting the segmentation plan in accordance with the spectral segment where interference was detected,
whereby interference immunity is achievable at least through adjusting the segmentation plan.

33. The system of claim 32, wherein the signal is modulated over the plurality of encoded signals within each of the spectral segments, whereby the spreading gain is the ratio of the sum of the bandwidth of the spectral segments and the transmission rate of the signal.

34. The system of claim 32, wherein the transmitter comprises a plurality of transmitters.

35. The system of claim 32, wherein the receiver comprises a plurality of receivers.

36. The system of claim 32, wherein the adjusting comprises removing from the segmentation plan the at least one spectral segment where interference was detected.

37. The system of claim 32, wherein the adjusting comprises increasing the power of the spectral segments at each of the spectral segments except the spectral segment where interference was detected and decreasing the power at the spectral segment where interference was detected.

38. The system of claim 32, wherein the adjusting comprises reassigning the signals transmitted from the at least one spectral segment where interference was detected to another spectral segment.

39. A method for segmented spread-spectrum communication, whereby the segmented spread-spectrum includes noncontiguous bandwidths, wherein the method comprises:
segmenting the available frequency bandwidth into a plurality of spectral segments and assigning each spectral segment a code according to a segmentation plan, wherein at least one of the plurality of spectral segments is noncontiguous with another spectral segment, whereby multipath effects are minimizeable through transmission of signals through the plurality of spectral segments;
receiving a first data signal and a second data signal;
replicating the first data signal into a plurality of first data signals;
replicating the second data signal into a plurality of second data signals;
encoding the plurality of first data signals and the plurality of second data signals using a plurality of unique codes, wherein the encoding creates a plurality of encoded first data signals and a plurality of encoded data signals; and
modulating the plurality of encoded signals according to the segmentation plan.

40. The method of claim 39, wherein the modulating comprises: modulating one of the first encoded data signals and one of the second encoded data signals within a spectral segment, wherein the code used to encode the one of the first encoded data signals and the code used to encode one of the second encoded data signals is associated with the spectral segment in the segmentation plan.
